(19) United States
(12) Patent Application Publication
(10) Pub. No.: US 2012/0044843 A1
(43) Pub. Date: Feb. 23, 2012

(54) Method of interconnecting multiple Electrical Vehicle Slave Charge Stations to a single Master Charge Station using a central hub or daisy chain connection means

(76) Inventors: Paul S. Levy, Chandler, AZ (US); Edward Butler, Gilbert, AZ (US); John C. Thomas, Beaverton, OR (US)

(21) Appl. No.: 12/858,428

(22) Filed: Aug. 17, 2010

(51) Int. Cl. H04W 40/00

(52) U.S. Cl. 370/310

(57) ABSTRACT

A method and system is provided in which multiple Slave Charge Stations are connected to a Master Charge Station which contains the single point metering method or power utility “smart meter” required by power utilities to access the power grid. This method describes the use of a plurality of Slave Charge Stations attached to the Master Charge Station using a daisy chain or hub and spoke attachment means.

### FIELD OF THE INVENTION

The present invention relates to the field of Master slave interconnect which is used to reduce costs when facilitating multiple electric vehicle charge stations within a small locus leveraging a single entry point for utility power and multiple points for distribution used to connect to electric vehicles for the purpose of recharging batteries. More specifically the present invention relates to a method and apparatus for interconnecting multiple satellite charge stations to a single master for the purposes of distributing power and getting authentication for charging electric vehicles.

### BACKGROUND

As electrical vehicles enter mass production there is a desire to conveniently extend operating range. Today, this range is extended by employment of a hybrid self-contained, gas fueled, and motor-generating set. As battery technology increases storage capacity, the need for self-contained power generation decreases. This increases the operating range of the electric only operating mode. This extended range will have the effect of changing the operating mindset to that similar to gas fueled in that the deployment of ubiquitous electrical charging stations extends the vehicle operation thus becoming un-tethered from its home base. The un-tethered concern is mitigated by lowering the cost of charge stations thus increasing market penetration and accessibility.

### SUMMARY OF THE INVENTION

In accordance with one aspect of the invention there is provided a Master Charge Station that is connected to the utility grid using a smart meter or similar measuring apparatus used to verify the amount of energy supplied by utility.

In accordance with another aspect of the invention there is provided a means of using a single master authentication means located in the Master Charge Station which is used to authenticate each electric vehicle and enable a charge event for each electric vehicle which is connected to a uniquely identified Slave Charge Station(s).

In accordance with another aspect of the invention there is provided a means of connecting a plurality of uniquely identified Slave Charge Station(s) to the Master Charge Station using a hub and spoke and/or daisy chain interconnect method.

In accordance with another aspect of the invention there is provided a method of attaching the unique identity of the Slave Charge Station that is connected to the electric vehicle to the datastream from the electric vehicle to the Master Charge Station.

In accordance with additional aspect of the invention each slave charge station contains a WireLine radio which is used to communicate to the attached electric vehicle which provides a connection between electric vehicle and the Master Charge Station which contains the required authentication means to verify the ownership of the electric vehicle connected to the uniquely identified Slave Charge Station.

In accordance with an additional aspect of the invention there is provided a switch means within each uniquely identified Slave Charge Station that is controlled by the by the Master Charge Station allowing a power connection between the electric vehicle, Slave Charge Station, interconnect cabling, Master Charge Station, enabling current to flow from the attached utility power into the electric vehicle.

In accordance with another aspect of the invention each Slave Charge Station contains a control module which is used to communicate to the Master Charge Station module enabling the Master Charge Station to control the Slave Charge Station switch allowing current to flow into the electric vehicle for charging.

In accordance with an additional aspect of the invention each Slave Charge Station contains a method to monitor current into the electric vehicle.

### BRIEF DESCRIPTION OF THE DRAWINGS

Other aspects and advantages of the invention will become apparent upon reading the following detailed description and upon reference to the drawings in which:

FIG. 1. Is a functional diagram illustrating a daisy chain method connecting two or more Slave Charge Stations connected to one Master Charge Station.

FIG. 2. Is a functional diagram illustrating a hub and spoke method connecting two or more Slave Charge Stations connected to one Master Charge Station.

FIG. 3. Is a functional block diagram of the Master Charge Station illustrating the placement of the smart meter, authentication module, power distribution connection to the utility and to the Slave Charge Station(s), and connection to an electric vehicle

FIG. 4. Is a functional block diagram of the Slave Charge Station illustrating the placement of the control module, switch, power feed from the Master Charge Station and connection to the electric vehicle.

FIG. 5. Is a functional flowchart illustrating how the communication packet from the electric vehicle is routed.

FIG. 6. Is a functional flowchart illustrating how the communication packet from the Master Charge Station is routed.

FIG. 7. Is a functional flowchart illustrating how a communication packet from the Slave Charge Station is routed

### DETAILED DESCRIPTION OF THE INVENTION

In the following detailed description numerous specifics are set forth in order to provide a thorough understanding of the present invention. However, the present invention may be used without understanding many of these specific details.

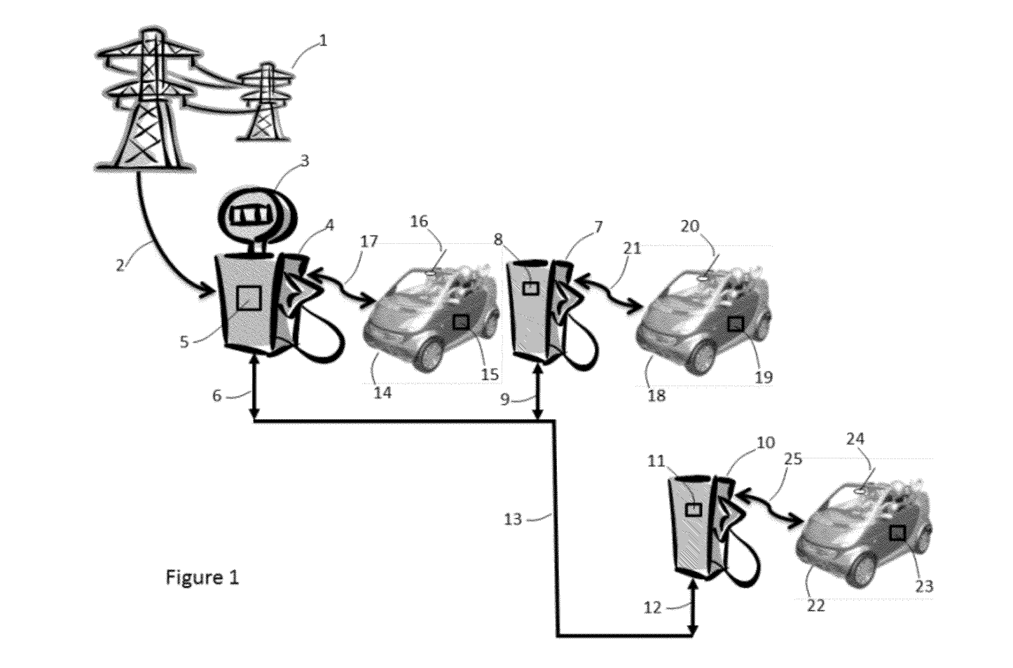

FIG. 1 illustrates the utility grid 1 shown connected to the Master Charge Station 4 using connection 2 which is used power to the master of charge station through smart meter 3. When an electric vehicle is connected via 17 to the Master Charge Station 4, Control board 5 is used to authenticate electric vehicle 14 by communicating to control board 15 by means of a WireLine radio which is in communication with the cloud using a wireless radio connected to antenna 16 that is also connected to control her board 15.

Referring to FIG. 1, Electric vehicle 18 when connected to Slave Charge Station 7 using connection 21, a request for charge from Control Board 19 is routed to the Master Charge Station control board 5 by 9, 13, 6 via WireLine radio and is authenticated by control board 5. The Master Charge Station via control board 5 enables the switch located on control board 8 allowing current to flow from the utility power through 2, 6, 13, 9, and 21 which connects the electric vehicle.

Referring to FIG. 1, Electric vehicle 22 when connected to Slave Charge Station 10 using connection 25, the request for charge from control board 23 is routed to the Master Charge Station control board 5 by 12,13,6 via a WireLine radio and is authenticated by control board 5. The Master Charge Station via control board 5 enables the switch located on control Board 11 allowing current to flow from the utility power through 2, 6, 13, 12, and 25 which connects the electric vehicle

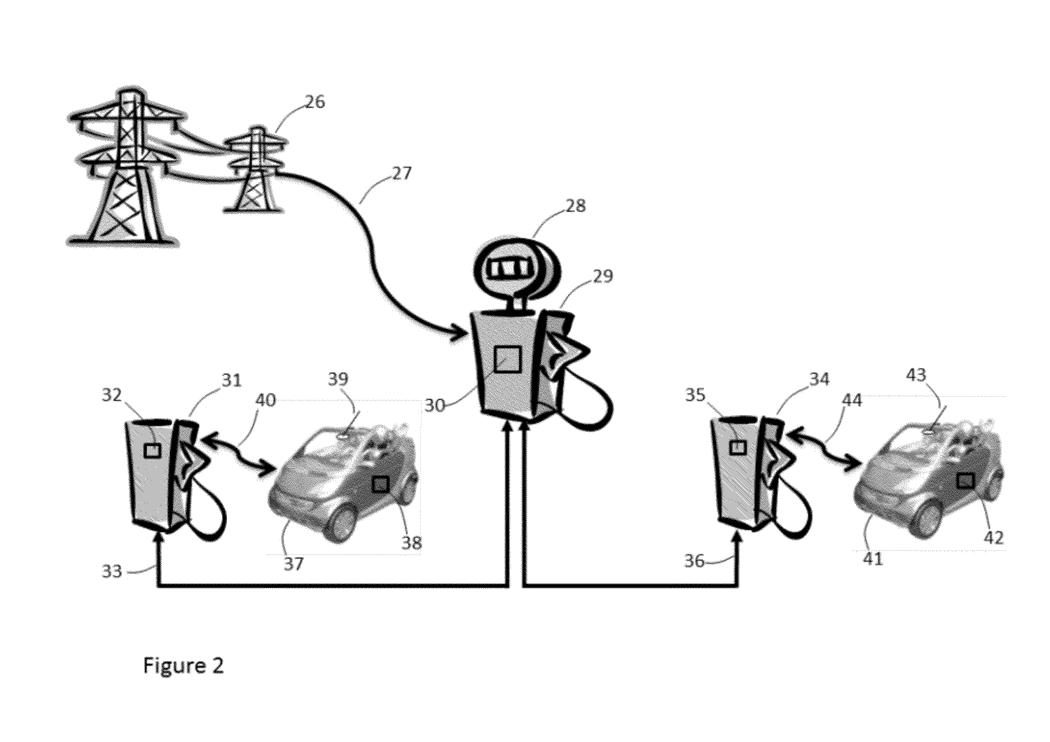

FIG. 2 illustrates the utility grid 26 shown connected to the Master Charge Station 29 using connection 27 which is used power to the master of charge station through smart meter 28.

Referring to FIG. 2, The Electric Vehicle 37 when connected to Slave Charge Station 31 using connection 40, a request for charge from Control Board 38 is routed to the Master Charge Station control board 30 by connection 33 via WireLine radio and is authenticated by control board 30. The Master Charge Station via control board 30 enables the switch located on control board 32 allowing current to flow from the utility power through 27, 33 and 40 which connects to the Electric Vehicle.

Referring to FIG. 2, The Electric Vehicle 41 when connected to Slave Charge Station 34 using connection 44, the request for charge from control board 42 is routed to the Master Charge Station control board 30 by connection 36 via a WireLine radio and is authenticated by control board 30. The Master Charge Station via control board 30 enables the switch located on control Board 35 allowing current to flow from the utility power through 27,36 and 44 which connects to the Electric Vehicle

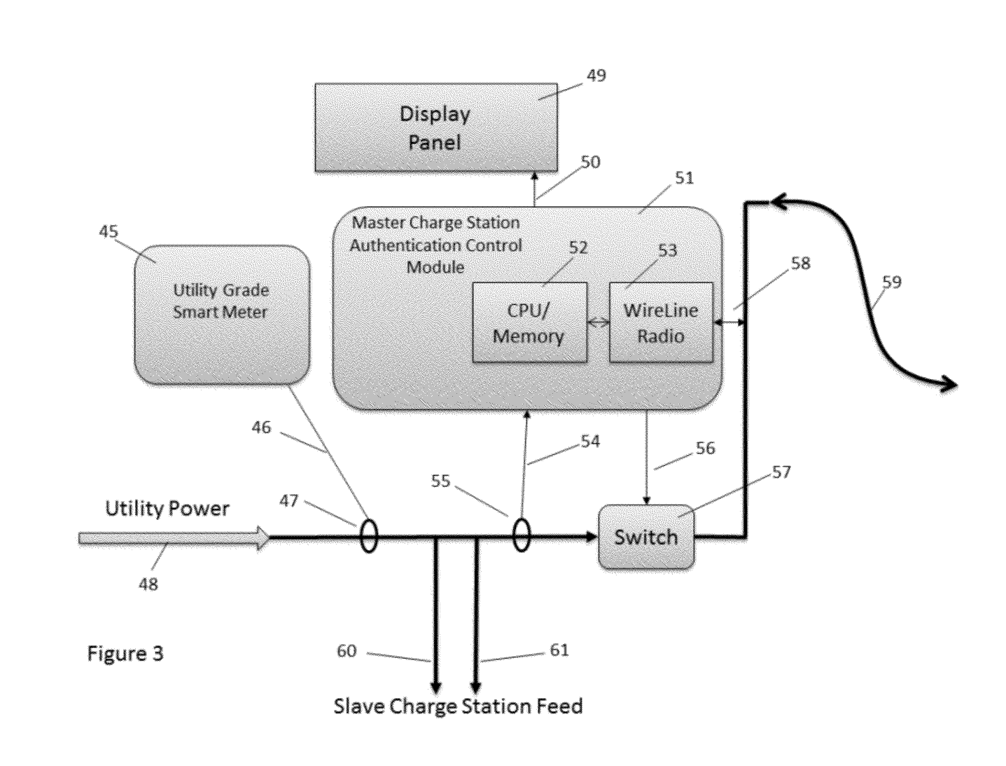

FIG. 3 illustrates a specific embodiment of the Master Charge Station circuit board in greater detail. Utility power 48 flowing to each Charge Station is picked up by current transformer 47 which is attached to utility grade smart meter 45 via connection 46. Connection 48 defines the input to the Power Network indicated by 60 and 61. Master Charge Station authentication module 51 receives current flow information from current transformer 55 via connection 54. The electric vehicle is connected via 59. Communication packets route between the Electric Vehicle and the Master Charge Station utilizing WireLine radio 53 which uses connection 58 to connect to the Electric Vehicle. The communication packets from the electric vehicle are processed using the processor memory complex 52. The display panel on the Master Charge Station 49 is driven by the Master Charge Station authentication control module 51 via connection 50. Once a charge of and is authenticated the Master Charge Station authentication control module sends a command to switch 57 via connection 56 to start a charge event.

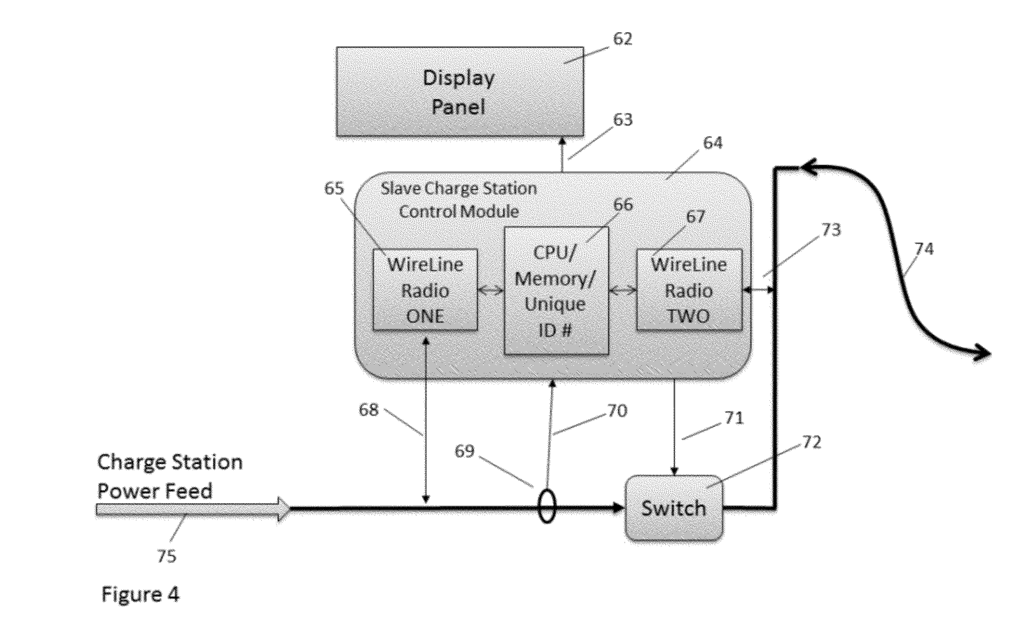

FIG. 4 illustrates a specific embodiment of the Slave Charge Station in greater detail. Main power supplying the Slave Charge Station from the Master Charge Station is connection 75. The Electric vehicle is connected to the Slave Charge Station via 74. Communication packets from the Electric vehicle is sent to WireLine radio to 67 via connection 73. The Slave Charge Station unique ID is appended to the electric vehicle communication packet using CPU complex 66 and spent to the Master Charge Station via a WireLine radio one 65 using connection 68. Communication packets from the Master Charge Station is received from WireLine radio one 65 via connection 68 and is processed using CPU complex 66. If the CPU complex 66 determines the packet is for the electric vehicle the appended unique ID of the Slave Charge Station is removed and 42 WireLine radio to 67 via connection 73 to the electric vehicle. It the CPU complex 66 determines the packet is for control of the Slave Charge Station the instructions from the packet are processed locally using the same CPU complex 66. The switch 72 is used to connect current from the Master Charge Station to the electric vehicle for a charge of that and is controlled by the computer complex 66 the connection 71. Display panel 62 is also controlled by computer complex 66 feet connection 63.

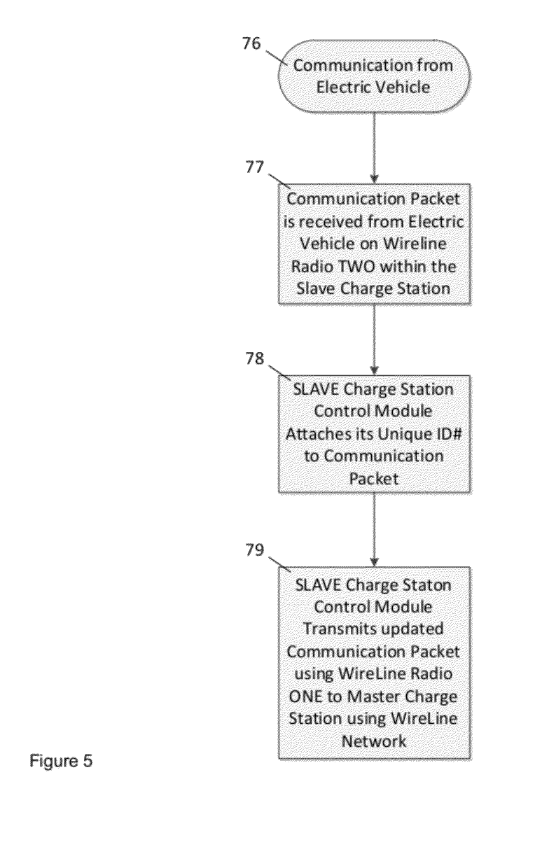

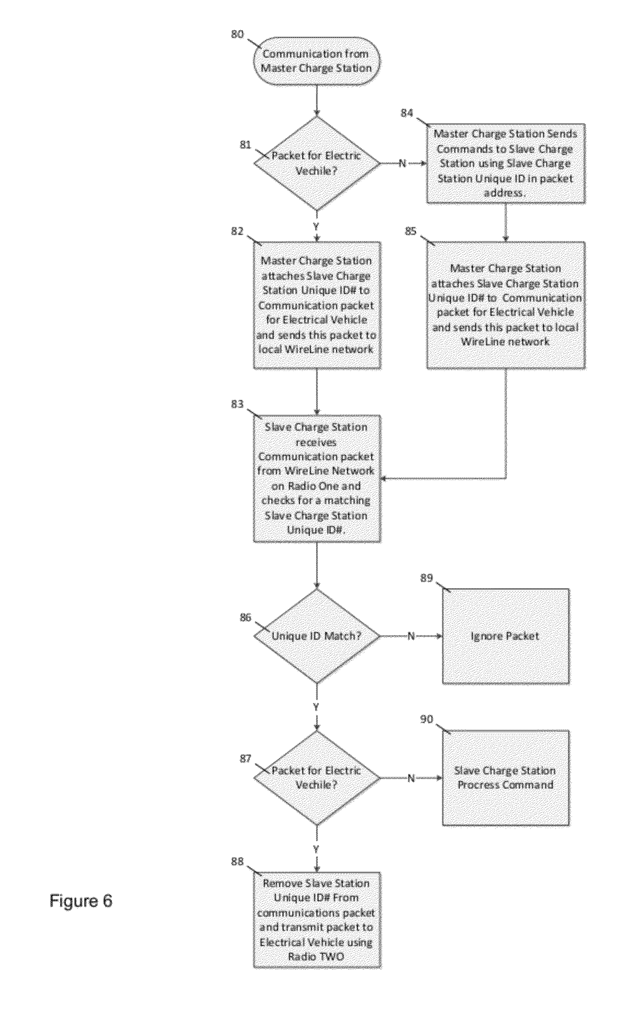

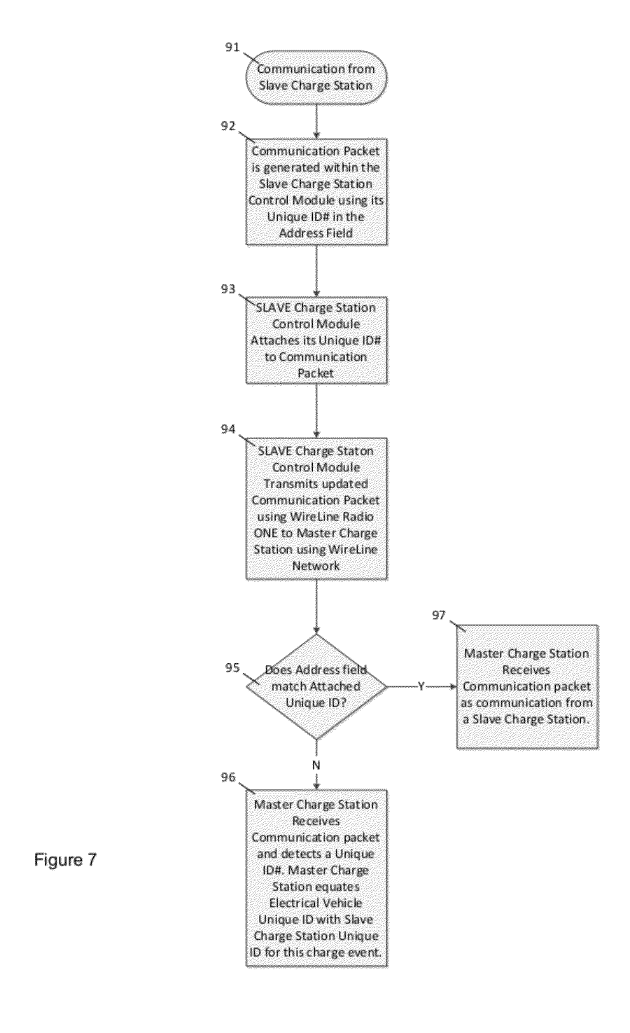

General routing methods of the three basic communication sources are illustrated in flowcharts FIG. 5, FIG. 6 and FIG. 7 which flow across the Power Network.

FIG. 5 illustrates how communication packets are received and routed when an Electric Vehicle is connected to a Slave Charge Station. The communication packet from the electric vehicles is received by WireLine Radio TWO within the Slave Charge Station, 77. The computer complex within the Slave Charge Station appends its unique ID to the electric vehicles communication packet 78. This communication packet is re-transmitted to the Master Charge Station using WireLine Radio ONE 79.

FIG. 6 illustrates how communication packets are received by the Master Charge Station from the Slave Charge Station. Communication packets generated by the Slave Charge Station for status will have its unique ID in the address field 92. The Slave Charge Station will also append its unique ID to the communication packet 93. The Slave Charge Station then uses a WireLine radio to transmit the communication packet to the master chart station using WireLine power network 94. The Master Charge Station compares the address field with the appended ID to determine the source of the packet 95. If the address equals the appended unique ID then the packet was status information from the Slave Charge Station 97. If the address does not equal the appended unique ID than the packet received was from the electric vehicle and the Master Charge Station processes the contents accordingly 96.

FIG. 7 illustrates how communication packets are generated by the Master Charge Station based on the intended target being either the Slave Charge Station or the attached electric vehicle 81. When the Master Charge Station sends commands to the Slave Charge Station, the communication packet will contain the Slave Charge Stations unique ID in the address field 84. The Master Charge Station then appends the communication packet with the Slave Charge Stations unique ID 85. If the Master Charge Station intended target is the electric vehicle, unique ID of the Slave Charge Station is appended to the communication packet 82. Either packet is then transmitted using a WireLine radio on the power network and there is received by all Slave Charge Stations 83. Each Slave Charge Station checks the appended unique ID for a match 86 to determine whether or not this packet is valid. If not valid the packet is ignored 89. If the unique ID matches the Slave Charge Station's unique ID the packet is valid and the Slave Charge Station's computer complex determines whether it's to be processed locally by comparing the address with unique ID 87. If the address and unique ID are equal the command is processed by the Slave Charge Station 90. If the address and unique ID do not match the unique ID is removed from the communication packet and a communication packet is forwarded to the electric vehicle 88.

1) A system comprising:
a. A Master Charge Station including: a smart utility meter, control module with a Micro-Processor, WireLine Radio, Electric Vehicle Charge Switch, Electric Vehicle power connection, Slave power distribution connections. PowerLine Network Connection, Utility power Connection.
b. A Slave Charge Station including: a Slave control module with the unique ID, PowerLine Network Connection to a Master Charge Station, Electric Vehicle Charge Switch, WireLine radio, Wireline or Wireless Radio, Electric Vehicle power cable.
c. PowerLine Network

2) System of claim 1 wherein utility power is connected to the Master Charge Station by the Utility Power Connection.

3) System of claim 1 wherein each communication packet from an Electric Vehicle connected to a Slave Charge Station is received by a WireLine Radio on a point to point Electric Vehicle Power Connection.

4) System of claim 1 wherein the received communication packet is appended with the Slave Charge Station unique ID number.

5) System of claim 1 wherein the appended communication packet by the Slave Charge Station is transmitted by a Wireless or WireLine radio that is attached to the PowerLine Network or over the air to the Master Charge Station

6) System of claim 1 wherein the Slave Charge Station generates a Status packet by using its unique ID in the address field and appending the packet by its unique ID and transmitted by a WireLine radio that is attached to the PowerLine Network or a wireless Radio to the Master Charge Station.

7) System of claim 1 wherein the Master Charge Station receives a communication packed from a Slave Charge Station by a WireLine Radio attached to the PowerLine Network or a wireless radio.

8) System of claim 1 wherein the Master Charge Station Pairs the Slave Charge Station unique ID with the attached Electric Vehicle's Unique ID by means of appending the Slave Charge Station Unique ID to the communication packet.

9) System of claim 1 wherein the Master Charge Station receives status from the Slave Charge Station by comparing the Communication Packet Address with the appended Unique ID number.

10) System of claim 8 Wherein the Master Charge Station directs transactions to a Slave Charge Station attached Electric Vehicle by appending the paired Slave Charge Station's unique ID to the communication packet.

11) System of claim 9 Wherein the Master Charge Station directs commands to a Slave Charge Station by appending the Slave Charge Station's unique ID to the communication packet.

12) A Secure Distributed Point of Sale system comprising in combination:
a. A Master Charge Station comprised of: a smart utility meter, control module with a Micro-Processor, WireLine Radio, Electric Vehicle Charge Switch, Electric Vehicle power connection, Slave power distribution connections. PowerLine Network Connection, Utility power Connection.
b. A plurality Slave Charge Stations comprised of: a Slave control module with the unique ID, PowerLine Network Connection to a Master Charge Station, Electric Vehicle Charge Switch, One WireLine Radio, One Wireline or Wireless Radio second electric vehicle power cable.
c. PowerLine Network
d. A plurality of Electric Vehicles comprised of: an Electric Vehicle Authentication Control Module, a Wireline Radio, a Wireless Radio.

13) The system of claim 12 wherein an encrypted communication session between the Electric Vehicle Authentication Control Module and the Master Charge Station control module by means of a Slave Charge Station that is connected to the Electric Vehicle.

14) The system of claim 13 wherein the unique address of the Slave Charge Station that is connected to the Electric Vehicle requesting a charge is inserted in communication between the Electric Vehicle and the Master Charge Station.

15) The system of claim 14 wherein control messages are sent from the Master Charge Station to the Slave charge Station which is connected to the Electric Vehicle requesting a charge using the inserted unique address.

16) The system of claim 14 wherein the Master Charge Station appends all communication responses by the unique address received from the Slave Charge Station which is connected to the Electrical Vehicle requesting a charge which is repeated to the Electric Vehicle by the Slave Charge Station repeater.

17) The system of claim 14 wherein status to a command sent from the Master Charge Station to the Slave Charge Station that is connected to the Electric Vehicle is sent from the Slave Charge Station that is connected to the Electric Vehicle to the Master Charge Station by using the unique address of the Slave Charge Station that is connected to the Electric Vehicle.
